(19) United States
(12) Patent Application Publication
(10) Pub. No.: US 2019/0002127 A1
(43) Pub. Date: Jan. 3, 2019

(54) AUTONOMOUS DOCKING STATION FOR DRONES

(71) Applicant: AIRSCORT LTD., Jerusalem (IL)

(72) Inventors: Itai STRAUS, Moshav Ora (IL); Yitzhak TAL, Jerusalem (IL)

(21) Appl. No.: 16/063,398

(22) PCT Filed: Dec. 21, 2016
(86) PCT No.: PCT/IL16/51362

§ 371 Date: Jun. 18, 2018

Related U.S. Application Data
(60) Provisional application No. 62/270,230, filed on Dec. 21, 2015.

(51) Int. Cl. B64F 1/00; B64F 1/12; B64F 1/22; B64F 1/36; G08G 5/00; B64F 1/20; G08G 5/02; B64C 39/02; H02J 7/35; H02S 20/30

(52) U.S. Cl. CPC B64F 1/007; B64F 1/12; B64F 1/222; B64F 1/362; G08G 5/0043; B64C 2201/20; G08G 5/025; G08G 5/0091; B64C 39/024; H02J 7/355; H02S 20/30; B64F 1/20

(57) ABSTRACT

A solution to the problem of short battery life of drones and operation in isolated or distant areas of service, by means of docking station/stations that allow for the autonomous landing/takeoff, storage, recharging and/or battery swapping for the drone/drones. The station is multi-cell station for drones with one or more landing/takeoff cells; at least two docking/storage cells; a transitioning closed-loop system configured for transporting the drones within the landing/takeoff cells and docking/storage cells; and control means configured for autonomous control, operation and management of the multi-cell station, where each one of the one or more landing/takeoff cells and at least two docking/storage cells shares at least two sides with neighbouring cells. Recharging mechanism for recharging the stored drones and transitioning mechanism for circulating the drones within the cells of the station are also provided.

### TECHNICAL FIELD

The present invention pertains to drone docking stations. More particularly, the present invention pertains to modular, scalable docking stations for autonomous landing, takeoff, docking and electrical recharging of drones using remote wireless supervision and control, which are particularly advantageous for continuous missions or isolated or distant areas of service.

### BACKGROUND

Drones are being used for a wide range of application mainly due to their autonomous capabilities. Drones are already being utilized to aid various industries including agriculture, security, package shipments, 3D mapping, pipe-line monitoring, construction and many more. The autonomous applications for drones are truly endless but they often require hours of air time, which is not met by their short battery life. Specifically, drones battery can only provide between 15 to 20 minutes of flight time (depending on payload, wind conditions etc.) which makes even the most revolutionary autonomous applications a huge hassle if every 15 minutes or so the drone needs to land to be manually recharged. This and several other factors make the use of drones for commercial applications cumbersome and dependent on pilots who must land, recharge and re-launch the drones.

Stations harbouring a plurality of drones, potentially useful for serial launching are described in the prior art, specifically in WO 2016/130112 and WO 2015/195175. However, these stations are actually aggregation structures of standalone landing and takeoff stations that still require human-aided charging of the drones' battery and consume at least the accumulated amount of resources of each station.

It is, therefore, an object of the present invention to provide a multi-cell station for landing, takeoff, recharge and docking of drones that overcomes the deficiencies of the prior art.

It is yet another object of the present invention to provide a multi-cell station for autonomous landing, takeoff, recharge and docking of drones with only remote supervision and control.

It is yet another object of the present invention to provide modular, scalable multi-cell station for autonomous landing, takeoff, recharging and docking of drones.

This and other objects and embodiments of the present invention shall become apparent as the description proceeds.

### SUMMARY

In one aspect, the present invention provides a solution to the problem of short battery life of drones and operation in isolated or distant areas of service, by means of docking station/stations that allow for the autonomous landing/takeoff, storage, recharging and/or battery swapping for the drone/drones.

This solution enables fully autonomous missions, particularly for commercial drones. Further, this solution for multi-docking of drones dis-intermediates the pilot and allows for complete mission autonomy by facilitating the drones' take-off, flight, precision landing, recharging, mission upload and storage. This, of course, both greatly enhances utility and very significantly reduces operational costs.

In view of the above, the present invention provides in one particular embodiment a multi-cell station for drones comprising: one or more landing/takeoff cells;

at least two docking/storage cells;

a transitioning closed-loop system configured for transporting the drones within the landing/takeoff cells and docking/storage cells; and

control means configured for autonomous control, operation and management of the multi-cell station,

where each one of the one or more landing/takeoff cells and at least two docking/storage cells shares at least two sides with neighbouring cells.

In still another aspect, the design of both the landing/takeoff station and the storage station is modular and scalable. If an application only requires one drone to be used then a single landing/takeoff station is sufficient. If however an application requires numerous drones, then the required amount of storage stations may be connected to the landing/takeoff station to create a larger station for the drones to be stored and recharged in.

The multi-cell station of the present invention essentially comprises a plurality of cells for docking drones, where one or more cells are landing and takeoff cells neighbouring at least two docking cells, and where each docking cell shares at least two sides with neighbouring cells that may be docking or landing and takeoff cells. Further, the structure that the cells form is modular and scalable, namely the structure can be expanded with the addition of cells for docking drones in one or more stories.

To enable the landing and takeoff of the docking drones in and off the station, the station comprises a transitioning mechanism for advancing the drones to and from the landing/takeoff cell from and to the docking cells, respectively. Any suitable transition mechanism may be applicable for continuous circulation of the drones within the cell structure. Particular examples may be closed loop railroad track, moving track bar, moving track chain and wheel based track.

A particular implementation of the transitioning mechanism comprises the following:

a closed-loop track chain;

a central gearwheel;

a side gearwheel;

a closed-loop belt; and

a motor in pivotal/axial communication with the central gearwheel,

where the closed-loop track chain wraps around the central gearwheel,

the central gearwheel is in axial communication with the motor at a bottom of a cone,

the cone is configured in upside down position to harbour the drone, and

the closed-loop belt warps around bottom of the gearwheel and the side wheel.

This is detailed further in the description and illustrated in the accompanying drawings.

In still another particular embodiment, the multi-cell station further comprises an autonomously operating recharging mechanism for recharging the drones in their docking cells. This recharging mechanism enables the autonomous connection for recharging and disconnection before taking off of the drones. Further, the recharging mechanism comprises a single closed circuit for recharging the drones and is configured to enable simultaneous recharging of a plurality of drones without installing electrical circuit in every docking cell.

In one particular embodiment, the recharging mechanism is implemented with the following assembly:

two upper spring-loaded pogo pin contacts on top of the drones;

two lower spring-loaded pogo pin contacts at distal ends of legs of the drones;

top retracting device on inner side of cover of the landing/takeoff cell and docking/storage cell; and

contacts at bottom of a cone positioned upside down within the landing/takeoff cell and docking storage cell,

where the spring-loaded pogo pins on top of the drones and retracting device are configured to close a circuit, and

the spring-loaded pogo pin contacts at lower end of the drone and contacts at bottom of the cone are configured to close a circuit.

To complete the autonomous operation, in one particular embodiment, the supervision, operation and management of the multi-cell station for docking drones of the present invention is done with dedicated software that coordinates the flight schedule of the stored drones according to flight missions to which they are enlisted. When a drone is needed for a mission, the software notifies the station that it should turn the drone that currently docks in the landing and takeoff cell on and open the lid of the cell. The lid is connected to a motor that opens and closes the lid upon command from the software. Once the drone is on and the lid of the station has opened the drone is free to leave the station and start the mission. The drone takes off vertically and once the drone is clear of the station the lid closes again. Continuous with such routine, in still another particular embodiment, the transitioning mechanism in the multi-cell station of the present invention advances a drone docking in a neighbour cell to the landing/takeoff cell.

When the mission is complete or the battery on the drone is running low, the drone flies back to the station for re-charging and storage. In one embodiment, the drone uses its on-board GPS to fly back to the coordinates of the docking station. However, the GPS is not accurate enough to precisely land the drone in the station because it has a deviation of several meters. Accordingly, in still another particular embodiment, the present invention comprises an autonomous navigation system for accurately navigating a drone to and from multi-cell station. This system essentially comprises the on-board GPS on the drone, on-board camera and complementing software for image processing and IR (Infra Red) beacon at the station. The on-board GPS of the drone brings it to the vicinity of the station. Then the on-board camera with the image processing technology locks onto a beacon emitting infrared light from the station. The camera on the drone locks onto the light and controls the drone to accurately land on top of the beacon which is in the center of the station.

In addition, or in place of an image processing solution, a real-time kinematics (RTK) technology may be suitable for precision landing of the drones in the station.

The multi-cell stations of the present invention are designed to protect the drones when in the station all year round and from various weather conditions. These stations are configured for onsite service and therefore allow the drone to leave for a mission whenever needed. Therefore, in one particular embodiment, the multi-cell station of the present invention further comprises an array of sensors that detect the outside conditions. These sensors provide weather data such as wind, temperature, barometric data, humidity and precipitation conditions and weather forecast to determine whether to launch a flight mission or postpone it. It should be noted that the system is configured to operate in harsh weather conditions, e.g., rain and/or wind, therefore all the electronics in the station are protected against water penetration and damage. Further, the station may also be fitted with fluid and air circulation devices and apparatuses, such as fans and air-conditioning channels, configured for providing proper drainage capabilities and air-circulation to make sure condensation of humidity does not accumulate in the station.

In another aspect, the present invention is configured to relay control of the station to remote control means and communicate station and flight mission to remote database. Beside the remote control and supervision capabilities, such remote means enable the management and administration of continuous flight missions divided to sub-missions assigned for consecutively launched drones. These capabilities are in conformity with the scope of the invention for centralized control and as drone operation as autonomous as possible of a plurality of drones, stored and docked in a multi-cell station.

The following describes particular exemplary embodiments of the present invention in further details with reference to the accompanying drawings and without departing from the scope of the present invention.

### BRIEF DESCRIPTION OF THE DRAWINGS

FIGS. 1A-B illustrate prior art landing/takeoff and docking station of the prior art

FIGS. 2A-2E illustrate modular scalable multi-cell station of the present invention.

FIGS. 3A-3C illustrate particular configurations of multi-cell station of the present invention.

FIGS. 4A-4E illustrate a transitioning system of the present invention.

FIG. 5A-5L illustrate recharging mechanism of the drones in the multi-cell station of the present invention.

FIG. 6 illustrates a removable side of a cell in a multi-cell station of the present invention.

FIGS. 7A-7C illustrate landing and takeoff positions of a drone in a docking/launch station of the present invention.

FIG. 8 displays the on-board electrical circuit of the present invention.

FIG. 9 illustrates photovoltaic cell recharging surface for stored drones in the multi-cell station of the present invention.

FIG. 10 illustrates wireless remote control system for controlling the multi-cell station of the present invention.

FIG. 11 is exemplary flow diagram for autonomous drone control and operation of the multi-cell station of the present invention.

### DETAILED DESCRIPTION OF THE DRAWINGS

FIGS. 1A-1B illustrate the currently used drone stations, which serve for landing/takeoff and storage. The major components such a station comprises are the cell itself (1A), cone shaped landing/takeoff and docking hub (6A) and sliding cover (2A) for opening and letting the drone (4A) take off and closing for storage.

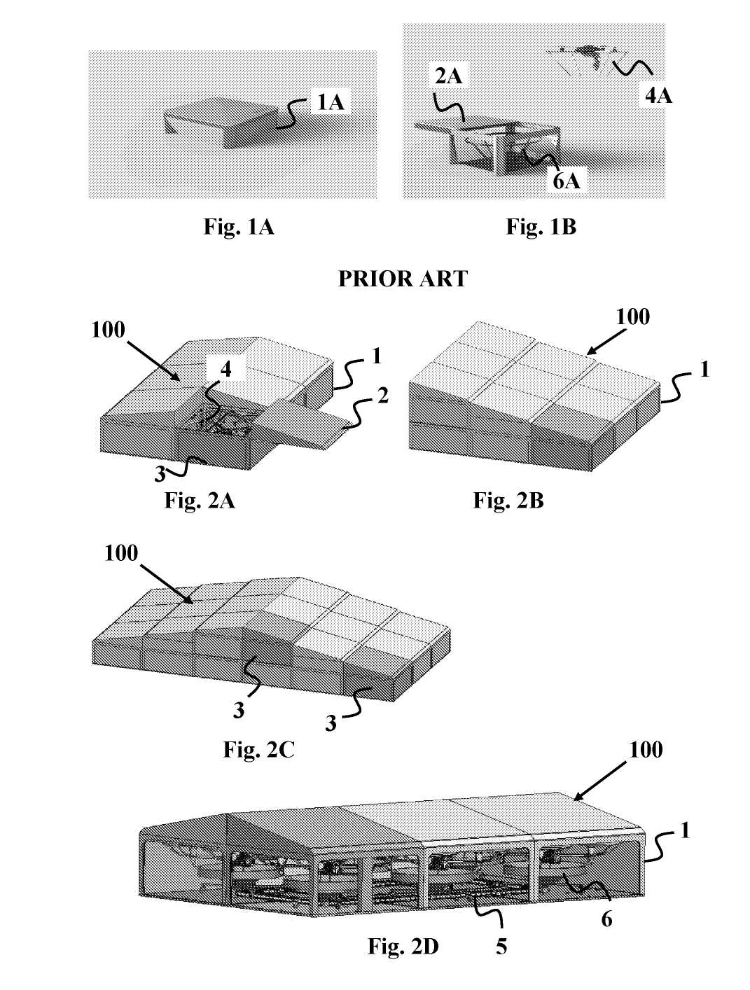

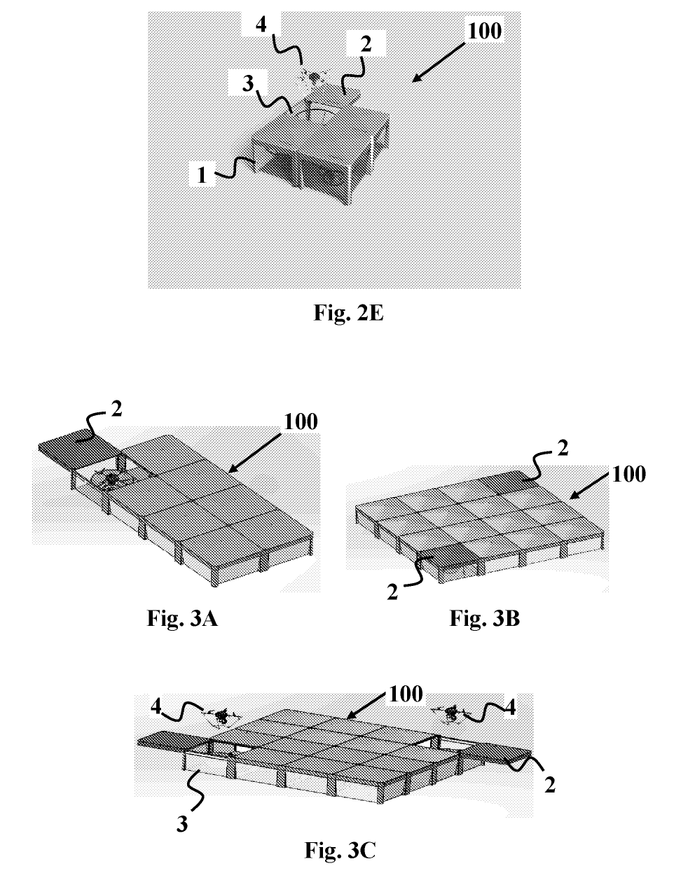

The advantageous concept of the present invention is illustrated in FIGS. 2A-2E, where different configurations of multi-cell station (100) comprises a plurality of docking cells (1) adjacent each other with at least two sides shared with neighbouring cells and one or more landing/takeoff cells (3). The docking cones (6) for harbouring the drones (4) are generally illustrated in FIG. 2D, where the cones are mounted on a transitioning mechanism for circulating them and the drones (4) inside them through the cells (1). Multi-story station (100) is illustrated in FIGS. 2C-2B, also showing one or more landing/takeoff cell (3) that services either all the drones (4) in all the cells (1) or only the drones in the story where the landing/takeoff cell (3) is installed.

There are various applications where more than one drone is needed, for example, security applications or time sensitive applications. When landing a drone in the station (100), the lid (2) should open. To this end, image processing technology to precisely land the drone in the station as discussed earlier is provided. Current technology is that for a plurality of drones, each drone would potentially need its own docking station. This however is costly because the station that is dedicated for the take-off and landing of the drone needs the extra technologies to make it work. The modular station (100) of the present invention overcomes the difficulties in such scenarios to keep the cost down for the customer. Essentially, the station (100) enables use of just one take-off and landing cell (3) as discussed above and addition of docking or storage cells (1) to it. This modular solution is illustrated in FIG. 2E and generally in all station configurations illustrated in FIGS. 2A-2E and 3A-3C.

The storage cells (1) attach to the landing/take-off cell (3). Once they are connected, they create a larger station for a plurality of drones to dock in. The drones only land and take-off in the landing/take-off cell (3), therefore the technologies needed for that are isolated to the landing/take-off cell (3). The docking/storage cells (1) do not need a retracting lid and do not need precision landing technology both of which add extra cost to the station. The present invention, therefore allows for a plurality of drones to be used in the most effective and cost efficient way.

A plurality of landing/take-off cells (3) could also be added if it is necessary to launch or receive more than one drone at the same time. FIGS. 3A-3C illustrate additional configurations of single-story multi-cell station (100) with one or more landing/takeoff cell (3) that service part or all the drones in the cells. A configuration of a station with two opposing landing/takeoff cells (3), such as illustrated in FIGS. 3B-3C, may prove more efficient, allowing simultaneous launch of two drones (4) at a time.

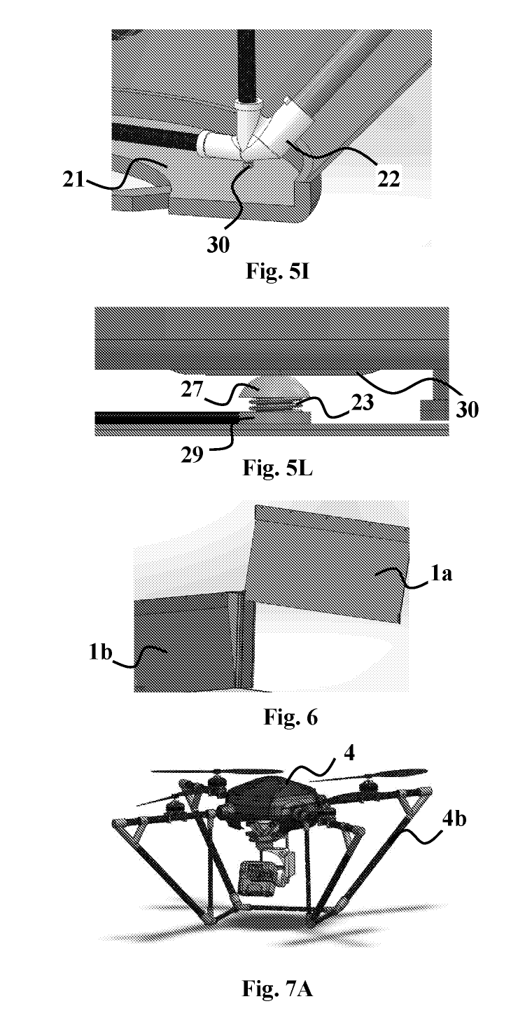

The walls (1a), (1b), on the docking cells (1) are designed to be able to be removed to connect the storage stations to them when needed as illustrated in FIG. 6. This creates an open space within the station (100), which allows for the installation and operation of the transitioning system within the station (100).

The docking/storage cells (1) are then easily connected and create a large station (100) capable of storing a plurality of drones (4). Each cell (1) added enables an addition drone to dock in the station (100). The minimum configuration to make this a relevant solution is having one landing/take-off cell (3) and three docking/storage cells (1) making up a station that can hold four drones (4). The reason for this is because the drones need to follow a closed loop circuit from the time they land until the time they take off. There are, however, a plurality of configurations that can be implemented for this solution that maintain the closed loop configuration. If large amounts of drones are needed, then more storage stations could be added as illustrated in the Figures discussed above.

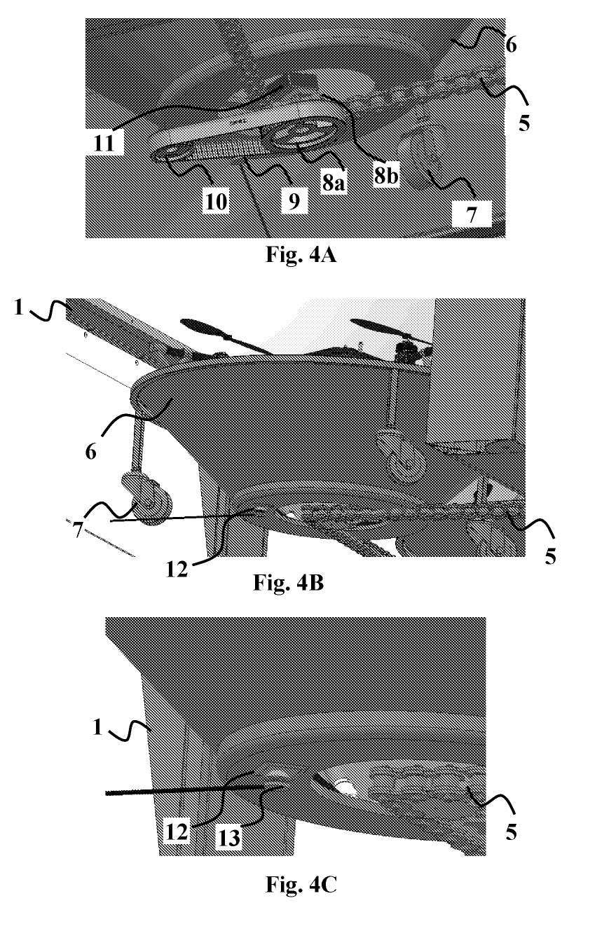

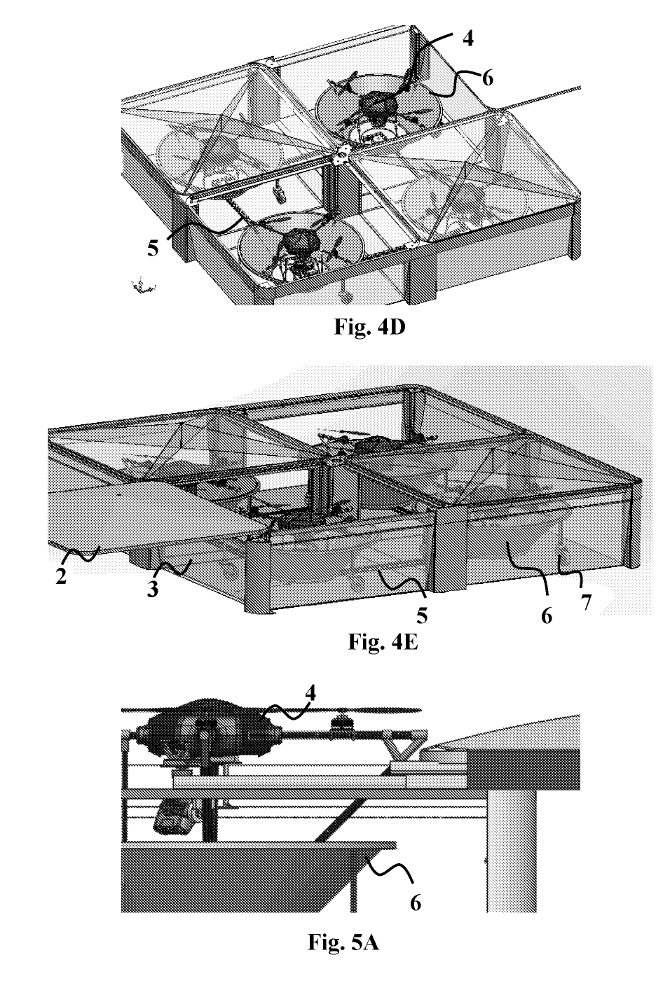

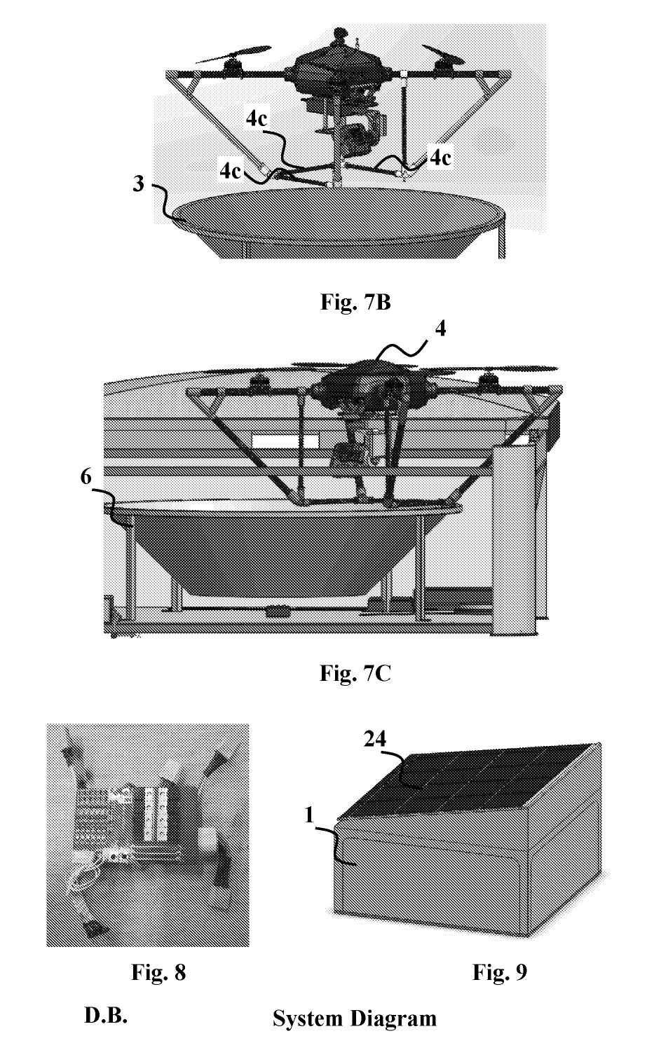

Referring to the transitioning system in further details, when the drones (4) land in the landing/take-off stations they land in a cone shaped device (6). The conical legs (FIG. 7A, 4b) on the drone (4) fit with the cone (6) in the cell (3) enabling millimeter precision when in the cell (3). The cones (6) are connected to a transitioning system, exemplified as a chain (5) in FIGS. 4A-4E that transfers the drones (4) from cell to cell. When docking/storage cells (1) are added making a modular station (100), the cone (6) that is used for holding the drone (4) is fitted with wheels (7) to aid in the transitioning between cells. FIGS. 4A-4E illustrate the transitioning system, e.g., chain (5) and the wheels (7) that are used to help the cones (6) transition.

Shown in FIGS. 7A-7C the legs (4b) of the drones for conical shaped legs that are used to aid the drone in precision landing. The precision landing is done with image processing which as mentioned above, however the conical legs help fine-tune the position of the drone in the station as it is landing. The legs (4b) also extend past the furthest point of the propellers acting as a protection to the propellers when the drone is landed in the landing/takeoff station (3). The legs (4b) are positioned at an angle of 45 degrees. The bottom of the legs (4b) form a three-sided rectangle shape (4c) which allows the drone to land outside of the station if necessary and still provides optimal field of view for the payload.

Some of the drones' most important features are discussed below

Flight controller—The flight controller is the most important component on a drone. The flight controller is the “brain” of the drone. It is connected to all the electrical components and controls them all to enable the flight of the drone. The present invention works with a range of flight controllers and therefore uses a range of drones with our solution. Obviously, the size of the drone is an important factor when using drones for commercial applications.

Size—The present invention is designed for commercial applications and therefore uses drones that are large enough to carry relatively heavy payloads (0.5 kg 3 kg on average) for extended amounts of time. The drones that are currently used are slightly over a meter long from edge to edge. What is important is that the stations are made to be minimal in size but still allow enough room for the drones to dock in. Also the stations are just the right size to allow the drones to transition from landing/take-off station to storage stations.

FIGS. 7A-7C depict the cone shape legs (4b) and the cone (6) in the cell (3) that is used to receive the drone. These Figures also show that even if the drone legs (4b) land on the side of the station, the angle of the legs still allows the drone to manoeuvre into the cone (6) allowing for more permissible deviation upon the drones landing into the cell.

In the center of both the landing/take-off cells (3) and the storage cells (1) there is a central gearwheel with tipper part (8b) around which a closed-loop chain (5) is wrapped and a lower part (8a) that connects with a side wheel (10) with a closed loop belt (9) for axial revolution. A motor (11) connects to the bottom of the drone (6) on one side and to the upper part (8b) central gearwheel (8b) on the other side in pivotal position to ensure movement of the cone (6) with movement of the chain (5). The central gearwheel (8a, 8b) in the landing/take-off cell (1) acts as a pinion and is motorized making all the drones (4) circulate through the array of cells. This happens when a drone (4) with a depleted battery enters the station and the drone that has been in the station for the longest (and therefore has a charged battery) is needed to take-off. The sidewheel (10) ensures stable axial revolution of the central gearwhell (8a, 8b) around its axis in the landing/take-off cell (1) making all the cones (6) with the drones (4) in them rotate and move to the cell next to the one they were just in. This is illustrated in FIGS. 4A-4E the gear and motor in the landing/take-off station that propels the transitioning system.

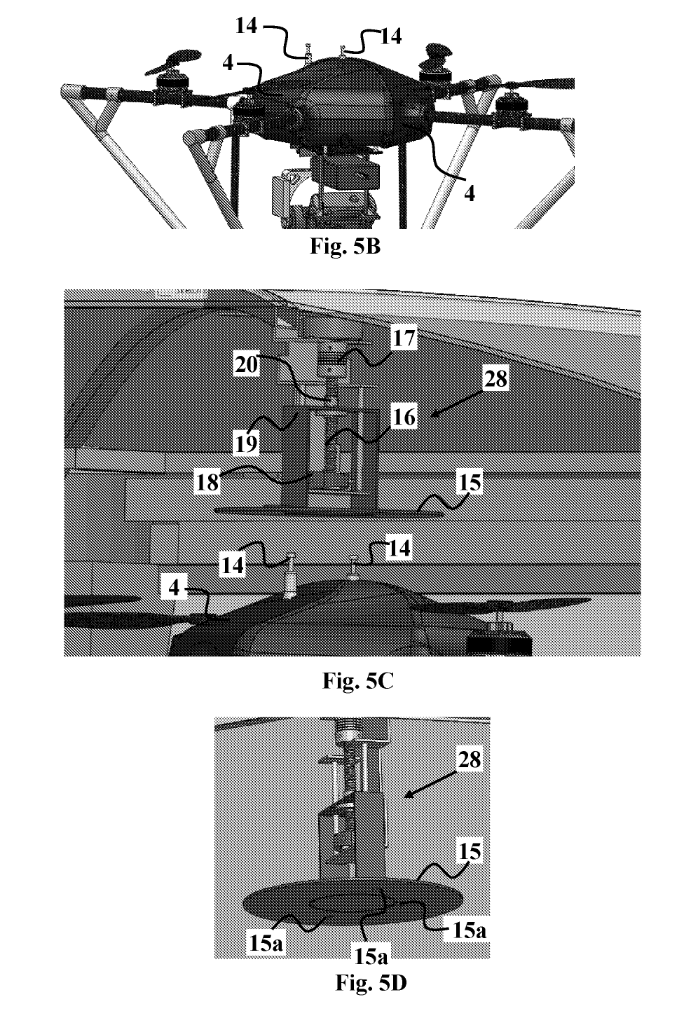

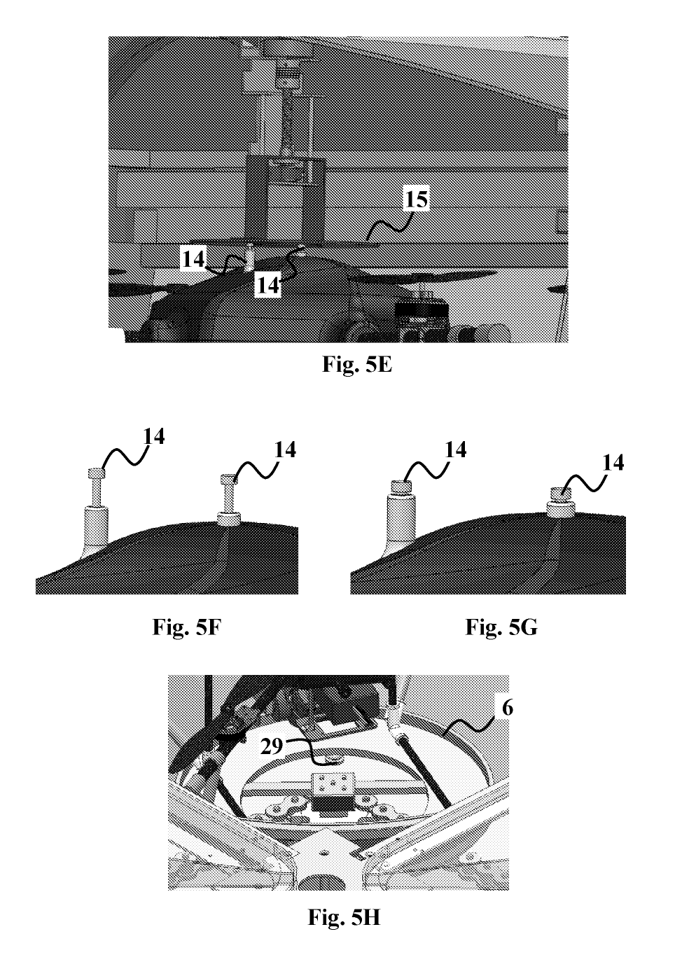

Each storage station has the electrical contacts necessary for the recharging of the drones when they are in the station as illustrated and exemplified in further detail in FIGS. 5A-5L. All the electrical contacts are circular to ensure contact irrespective of the drone's rotation. FIG. 4B depicts the contact (12) at the bottom of the cone (6) that was discussed earlier. FIG. 4C depicts a contact (13) that is under the cone (6) that connects to the contact (12) in the cone (6). The recharging method works in the same way as in the landing/take-off cell. All the docking/storage cells (1) are connected to the electronics of the landing/take-off cell (3), therefore only one charger and electric circuit is needed for the whole array of cells. To allow for autonomous recharging, closing an electrical circuit with four connections is needed. Two connections come in contact with the drone (6) from the conical device (6) and two come in contact from a retracting device (28 in FIGS. 5C-5E) from the roof of the cell. FIG. 5C illustrates a charging pad (15) and retracting device (28). Each docking/storage cell (1) is also fitted with this unit and when the drones (4) are transferred into the docking/storage cell (1) the contacts are reconnected for charging.

The retracting device (28) comprises a lower circular pad (15) that carries the contacts retracting device (15a) at its bottom surface to connect with pogo pins (14) on top of the drone. The pad (15) is held with a vertical lowering assembly that comprises rectangular hollow frame (19), screw (16) and nut (18) within the hollow frame (19), top stopper (20) mounted on the screw (16) and limiting the extend of vertical motion of the screw (16) by the top of the frame (19) and a connector (17) that connects a motor (32) above to the lead screw for lowering and elevating the retracting device (28) for closing the circuit for recharging. FIG. 5D illustrates a closer look of the retracting device (28) showing the lower pad (15) with the contacts (15a) that match the pogo pins (14) on the drone's top. FIGS. 5F-5G show the pins (15) in disconnection and connection states with the pad (15), respectively. FIGS. 5A-5B show, respectively, the drone (4) in settled position within the cone (6) and the drone (4) with two pogo pins (14) on the drone's top for closing two electrical contacts. FIG. 5E shows the retracting device (28) lowered towards the drone's top and closing a circuit with the pad (15) pogo pins (14).

Each docking/storage cell (1) has a pin (29 in FIG. 5L) that connects to a contact pin (27) at the bottom of the cone (6). The pin (27) is spring-loaded (23) pressed against, which enables to close a circuit with contact (30 in FIGS. 5I-5L) on the bottom of joint (22) that holds the drone's diagonal legs and lateral frame. This closes the bottom two contacts for closing a circuit for recharging as was discussed previously. This solution enables that the bottom contact (30) be connected to the electronics of the landing/take-off cell (3) when in the docking/storage cell (1).

When the docking/storage cells (1) are connected to the landing/take-off cell (3) there are electrical contacts that pair up and allow for the docking/storage cells (1) to recharge the batteries of the drone (4) when the drone is in the docking/storage cell (1). By connecting the docking/storage cells (1) to the electronic circuit in the landing/take-off cell (3) the costs are cut even more and allow for a quick and simple way to allow for continues charging even when in the docking/storage cells (1).

As detailed above, the present invention provides an on-board circuit that takes care of the autonomous charging once the drone has landed in the station. The drones that are currently used have 6-cell batteries. In order to charge them properly they need to be balanced charged, namely all the cells need to be charged at the same rate. This is done by connecting the plus and minus and an additional seven leads of the battery to the charger in order to make sure that all the cells are charged together and balanced. Since the present invention requires autonomous charging the amount of circuits that should be closed to allow for charging should be minimal.

For this, the drone comprises an on-board circuit that sits on the drone and takes care of the balance charging of the battery. This allows to only connect the plus and minus of the battery and not the other seven leads. It is important that the drone turns off prior to charging so the on-board circuit has two additional electrical leads that connect to the microcontroller (the microcontroller is the “brain” in the station) and when the microcontroller gives the signal the drone turns off and is connected to the charger for recharging.

FIG. 8 displays the on-board electrical circuit with the following contact functionalities that closes circuits with the different components of the electrical circuits for recharging:

The circuit has four plugs on it.

1. The battery plug.
a. The battery is connected directly to this plug.

2. The drone plug.
a. This plug is connected to the drone and gives power to the drone when the battery is connected to the battery plug.

3. The charger plug.
a. This plug is connected to two pogo pins (14) on the drone that when in the station come in contact with charging plates (15).

4. The signal plug.
a. This plug also connects to two pogo pins (14) and comes in contact with two plates (15 through contacts 15a) in the cell. These plates are connected to the microcontroller and when the signal on the microcontroller goes too low the transistor on the circuit switches its function and “disconnects” the drone plug and “connects” the charging plug and allows for the drone to turn off and the battery to be recharged.

In one particular embodiment, the batteries used for drones are lithium polymer batteries that are split into several cells. Depending on the size of the drone different batteries with different amounts of cells are used. The drones that are currently used work with a 6-celled lithium polymer (or Lipo) battery. The recharging system of the present invention works with all kinds of Lipo batteries and is not only limited to 6-celled batteries.

The docking station is controlled with a microcontroller and a communications device used for internet connectivity. The microcontroller takes care of all the physical elements of running the station including:
Powering the motor to open/close the lid
Connecting to micro switches determine when to stop the motor
Connected to a solenoid to lock the lid when closed
Connected to the beacon for precision landing
Connected to another motor for the charging pad
Connected to the charger for battery recharging
Connected to the drone to turn it off before charging and turning it on before take off

The station could be powered in a number of ways; by means of a wall outlet, a car jack, or even other power sources. If for example the station is located in an area where traditional power supplies are not available, the station could be charged by other means; for example a solar panel attached to the roof or located in the vicinity of the station. FIG. 9 illustrates a solar or photovoltaic cell charged charger using solar/photovoltaic panel (24) at the top of the cell (1). This is particularly effective when constructing and installing the station in isolated or distant service areas. This way no power lines should be extended to such places, exploiting the sun's radiation for direct recharging of the charger of the station.

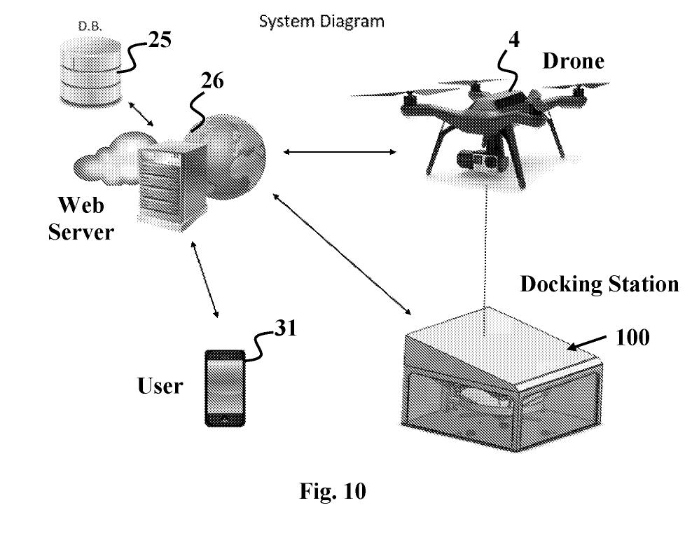

FIG. 10 illustrates remote control, supervision and data storage system based on cloud server platform. Generally, drones are powered by RF or radio frequency. RF is limited to a range of several kilometers. The present invention provides a method for controlling drones through a cellular connection. The advantages of using a cellular connection include not being limited by a range for the drone to fly in, but also it allows our cloud based server (26) to be in constant communication with the drone (4). Since the server (26) is connected to the drone, a remote user (31) constantly knows exactly what the status of the drone (4) is. Accordingly, the present invention comprises corresponding algorithms which constantly compute how far the drone is from the station (100), how much power the drone is consuming, when to send a new drone to take over the mission and when to send the drones back to base.

The station (100) is also connected to a cloud server (26), which enables to receive data on the charge status of the drones (4), the weather conditions in and outside of the station and allows controlling the station (100) and drone remotely.

Data download—One of the main objectives of using a drone for commercial applications is to gather data. The drone caries a payload, generally and camera and the camera collects data. Once the drone has landed in the station the data is transferred to the cloud server (26) and delivered to the customer. The customer does not need to be anywhere near the station (100) and drone (4) to receive the data because it is all online.

Mission upload—A drone can only fly autonomously if a mission is uploaded to it. Many commercial applications require hours of flight time and therefore requires that separate missions be uploaded for each individual flight. The present invention solves this issue as well, by customer upload of a mission that could potentially take hours. The software of the present invention is configured to split up the mission into submissions and send the appropriate mission to the drone before each flight.

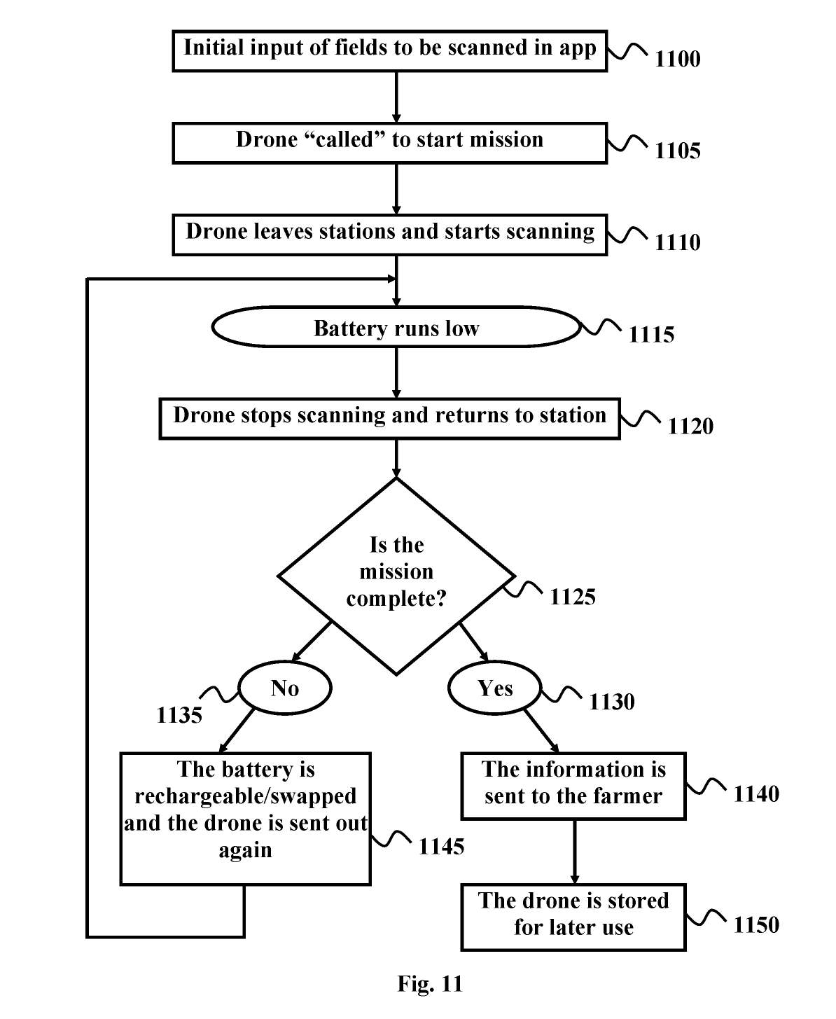

FIG. 11 details how the software of the application controls and manages the station in steps (1100) through (1150).

An example for an application where this technology could be useful is for the scanning of farmland to provide farmers with key information they need for precision agriculture.

For example, the station(s) could be installed on the roof of the barn of the farmer or any other location desired. The station can remain at that location year-round due to the fact that it is weather proof. When the farmer wants his fields scanned he can either have the drone(s) sent out by a phone or computer application or he can have the drone(s) pre programmed to scan his field at designated times (for example once a day, twice a week, five times a week etc.). With the designated software for agriculture the field can be pre programmed to be split up into sections that the drone can scan in the time span that the batter allows for. Once the first section is done being scanned and the battery is low, the drone can autonomously fly back to the station to either have the battery recharged or swapped. Once the drone has a fully charged batter it can leave the station again to scan the next section of the field. This process can be done over an over until the whole field is scanned. A designated camera can be attached to the drone and provide the farmer with the specific information that is needed. At the end of the mission, the information gathered can be automatically sent to the farmer's email or phone application or other device. The docking station solution allows for the farmer to receive this crucial information when he needs it and without any human intervention.

1. A modular and scalable docking station for drones comprising:
one or more landing/takeoff cells;
one or more docking/storage cells;
and
control means configured for autonomous control, operation and management of said modular and scalable docking station,
wherein said landing/takeoff cells are configured as said docking/storage cells, said landing/takeoff cells comprising means for docking/storage of said drones, said means comprising a cone, said cone is accommodated in said landing/takeoff and docking/storage cells and configured in upside down position to harbour said drones,
wherein said cone comprises wheels attached to its lower end, said wheels are in frictional communication with lower flat surface within said cells, and
wherein said modular and scalable docking station comprising at least one landing/takeoff cell which is a docking/storage cell.

2. The docking station according to claim 1, further comprising recharging means for recharging batteries of said drones.

3. The docking station according to claim 2, wherein said recharging means comprises:
two upper spring-loaded pogo pin contacts on top of said drones;
two lower spring-loaded pogo pin contacts at distal ends of legs of said drones;
top retracting device on inner side of cover of said landing/takeoff cell and docking/storage cell; and
contacts at bottom of a cone positioned upside down within said landing/takeoff cell and docking storage cell,
wherein said spring-loaded pogo pins on top of said drone and retracting device are configured to close a circuit, and
said spring-loaded pogo pin contacts at lower end of said drone and contacts at bottom of said cone are configured to close a circuit.

4. The docking station according to claim 2, wherein said recharging means is in communication with a microcontroller of said control means, said microcontroller is in communication with electrical leads of on-board circuit of said drones, said microcontroller is configured to command said on-board circuit to turn off through said electrical leads before electrically connecting to said recharging means and connect to said recharging means for recharging of said batteries of said drones.

5. The docking station according to claim 1, further comprising a transitioning closed-loop system configured for transporting said drones within said landing/takeoff cells and docking/storage cells, said transitioning closed-loop system is selected from closed-loop railroad track, moving track chain, moving track bar and wheel-based track.

6. The docking station according to claim 5, wherein said moving track chain comprises:
a closed-loop track chain;
a central gearwheel;
a side gearwheel;
a closed-loop belt; and
a motor,
wherein said closed-loop track chain wraps around said central gearwheel, said central gearwheel is in axial communication with said motor, said motor is in axial communication with bottom of, said cone, and said closed-loop belt warps around bottom of said gearwheel and said side wheel.

7. (canceled)

8. The docking station according to claim 1, further comprising remote control means comprising: a wireless communication network, a cloud-based server, a database and a remote user computer means, said remote control means is configured to monitor and supervise ongoing activity of flight missions of drones launched from said multi-cell station, divide a flight mission to sub-missions and delegate said sub-missions to said drones, receive data from said multi-cell station and said drones and store and process said data in a dedicated database and transmit real-time information to said user computer means.

9. The docking station according to claim 1, wherein said drones are configured to be accommodated in said upside down positioned cones in said landing/takeoff and docking/storage cells, said drones comprising diagonal inwardly oriented legs towards central axis of said drones, horizontal three side frame and joints connecting between distal ends of said legs and vertices of said frame.

10. The docking station according to claim 1, further comprising RTK (Real Time Kinematics) technology configured for precision landing of said drones at said landing/takeoff cell.

11. The docking station according to claim 1, further comprising navigation system comprising on-board GPS and camera and complementing software for image processing installed on said drones and IR (Infra Red) beacon at said station.

12. The docking station according to claim 1, further comprising an array of sensors configured to detect weather and surrounding conditions, said sensors providing weather data selected from wind, temperature, barometric data, humidity and precipitation conditions, weather forecast and any combination thereof.

13. The docking station according to claim 1, further comprising a charger and charging means in electrical communication with said charger for providing power to said charger.

14. The docking station according to claim 12, wherein said charging means comprises a solar panel mounted on outer surface of top of said landing/takeoff and docking/storage cells.

15. The docking station according to claim 1, wherein each one of said landing/takeoff cells and docking/storage cells is configured to share at least two sides with neighbouring cells.

16. The docking station according to claim 1, comprising at least one story comprising one or more landing/takeoff cell and a plurality of docking/storage cells.

17. The docking station according to claim 1, comprising two stories comprising one or more landing/takeoff cell and a plurality of docking/storage cells.

18. The docking station according to claim 16, comprising one or more of said landing/takeoff cell and one said transitioning closed-loop system in each one of said two stories, said transitioning closed-loop system is configured to transport said drones within said plurality of docking/storage cells and landing/takeoff cells in each one of said two stories independently of each other.

19. The docking station according to claim 3, wherein said recharging means is in communication with a microcontroller of said control means, said microcontroller is in communication with electrical leads of on-board circuit of said drones) said microcontroller is configured to command said on-board circuit to turn off through said electrical leads before electrically connecting to said recharging means and connect to said recharging means for recharging of said batteries of said drones.

20. (canceled)
